(19) United States
(12) Patent Application Publication
(10) Pub. No.: US 2016/0217447 A1
(43) Pub. Date: Jul. 28, 2016

(54) Dynamic Price Change Management

(71) Applicant: Shyamal K. Sarkar, Blauvelt, NY (US)

(72) Inventor: Shyamal K. Sarkar, Blauvelt, NY (US)

(21) Appl. No.: 14/604,623

(22) Filed: Jan. 23, 2015

(51) Int. Cl. G06Q 20/20

(52) U.S. Cl. CPC G06Q 20/201; G06Q 20/202

(57) ABSTRACT

A method and a system for dynamically managing prices of multiple items in a retail entity are provided. A price management system (PMS) is provided to operably communicate with transmission devices and receiving display terminals. Each receiving display terminal is positioned at the retail entity and/or a remote location. The PMS dynamically receives sales information of the items from billing sources at the retail entity and determines pricing data for the items based on the dynamically received sales information and pricing criteria. The PMS identifies one or more items requiring a change of the prices based on the determined pricing data. The PMS, in communication with a positioning unit of each receiving display terminal, locates the receiving display terminals associated with the identified items. The PMS transmits the determined pricing data for the identified items to the located receiving display terminals via the transmission devices at preconfigured time instants.

### BACKGROUND

Managing and operating retail businesses have changed significantly in the last decade. Large supermarkets and chain retail stores are replacing smaller retail establishments, for example, corner mom and pop stores for hardware, home improvements, drugs, clothes, home appliances, electronics, alcohol, etc. Retail businesses need to change prices of multiple retail items periodically. Changing prices of retail items on a continuous basis is time consuming with thousands of different retail items stocked on shelves of a retail store, and thousands of potential price changes taking place every week. Managing inventory and adjusting the prices of the retail items are complex and often difficult tasks. Although computerization of tasks involved in retail management has helped in managing the inventory, changing prices at the shelves of the retail store is still performed manually by changing display price tags for each retail item.

A stock keeping unit (SKU) is a unique identification number that refers to a specific stock item of a manufacturer. In the retail industry, the SKU is used in backend inventory control and management processes that enable a retailer to track retail items in the inventory that may be in a warehouse, or on shelves of the retail store. Typically, a supercenter such as the WAL-MART® supercenter of Wal-Mart Stores, Inc., deals with an inventory that has about 150,000 SKUs. Changing prices upwards and downwards for thousands of retail items periodically and frequently is labor intensive for any retail establishment. Recently, there has been an increase in the frequency of price changes in the retail business worldwide. Hence, display price tags for a specific SKU in the retail establishment have to be monitored periodically and changed manually to reflect rapid price changes. This manual price change is labor intensive and time consuming. Moreover, manually changing the prices of thousands of retail items at the retail establishment leads to a growing number of price management errors, for example, delays in displaying the changed prices, delays in reflecting the pre-promotion original prices, errors in updating the prices at the shelves of the retail store, errors in positioning display price tags on correct retail items at correct locations, inconsistent price changes due to retail management staff overlooking retail items the prices of which need to be changed, or the prices not being changed by the retail management staff for other reasons, etc. These price management errors incur a revenue loss for the retail establishment. Hence, there is a need for retailers to ensure that the prices of the retail items are accurate and are displayed accurately on the correct retail items, in a timely manner, to increase sales and customer satisfaction, thereby increasing revenue.

Sometimes, display terminals that display prices of the retail items are positioned at a high altitude, for example, on a pole or a tower to provide maximum visibility of the prices to customers. This positioning of the display terminals makes it difficult for retail management staff to change prices manually. For example, changing prices manually on a price display board positioned on a tower at a gas station may be inconvenient, due to weather conditions such as chilly weather or hot weather or due to physical inaccessibility to the price display board, and therefore, results in a delay in changing the prices. Manual intervention required to change prices rapidly and accurately on a price display board positioned at high altitudes or in physically inaccessible areas may cause revenue loss. Moreover, there is a lack of periodic maintenance of the display terminals and verification actions to ensure that changed prices are displayed accurately, in a timely manner, and for the right retail items. Furthermore, a retail chain typically has multiple outlets with multiple display terminals positioned locally or at multiple remote locations. Reflecting the price changes of retail items uniformly across all the display terminals across the outlets is often a tedious and time consuming task that needs to be repeated for each price change.

Perishable items cannot be salvaged once expired as these items become stale or spoilt. Currently, the revenue loss due to lack of sales management of perishable items is high in retail establishments. The expired perishable items do not have a resale value and often are not returnable for recovering lost credit. Retailers typically aim at exhausting the perishable items in their inventory by reducing the prices of the perishable items before the expiration dates of the perishable items, to minimize revenue loss. However, dynamically determining a time and a percentage of reduction of the prices of the perishable items with limited expiration dates and other items based on demand in a bid to attract customers is a cumbersome task for the management staff of retail establishments.

Hence, there is a long felt but unresolved need for a method and system that dynamically manages prices of multiple items in a retail entity in a uniform, convenient, accurate and time efficient manner, thereby minimizing potential revenue loss. Moreover, there is a need for a method and system that locates multiple display terminals associated with the items and positioned at multiple locations, using positioning units in order to manage prices of multiple items in real time, remotely, uniformly, and rapidly, thereby minimizing manual intervention and increasing resource efficiency of a retail entity. Furthermore, there is a need for a method and system that remotely manages maintenance of multiple display terminals for ensuring a uniform, accurate and timely display of changed prices in a retail entity.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and system disclosed herein addresses the above stated need for dynamically managing prices of multiple items in a retail entity in a uniform, convenient, accurate and time efficient manner, thereby minimizing potential revenue loss. Moreover, the method and system disclosed herein locates multiple display terminals associated with the items and positioned at multiple locations, using positioning units in order to manage prices of multiple items in real time, remotely, uniformly, and rapidly, thereby minimizing manual intervention and increasing resource efficiency of a retail entity. Furthermore, the method and system disclosed herein remotely manages maintenance of multiple display terminals for ensuring a uniform, accurate and timely display of changed prices in a retail entity.

The method and system disclosed herein provides a price management system comprising at least one processor, in operable communication with one or more transmission devices and multiple receiving display terminals. Each of the receiving display terminals is configured with a positioning unit and positioned at a retail entity or a remote location. The price management system dynamically receives sales information of the items from one or more of multiple billing sources at the retail entity. The price management system determines pricing data, for example, an updated price, one or more messages, etc., for the items based on the dynamically received sales information and pricing criteria. The pricing criteria comprise, for example, a type of an item, an expiration date of the item, a quantity of the item in an inventory of the retail entity, etc. The price management system identifies one or more items requiring a change of the prices based on the determined pricing data. The price management system, in communication with the positioning unit of each of the receiving display terminals, locates one or more receiving display terminals associated with the identified items. The price management system transmits the determined pricing data for the identified items to the located receiving display terminals via one or more transmission devices at one or more time instants configured by the price management system.

In one or more embodiments, related systems include but are not limited to circuitry and/or programming for effecting the methods referenced herein; the circuitry and/or programming can be any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a method for dynamically managing prices of multiple items in a retail entity.

FIG. 2 exemplarily illustrates a flowchart comprising the steps for dynamically managing prices of multiple items in a retail entity, where receiving display terminals at one or more of multiple locations are located and pricing data is transmitted to the located receiving display terminals via one or more transmission devices.

FIG. 3 exemplarily illustrates a flowchart comprising the steps for dynamically managing prices of multiple items in a retail entity, where a sales pattern associated with an item is determined for determining pricing data of the item.

FIG. 4 exemplarily illustrates a flowchart comprising the steps for dynamically managing prices of multiple items in a retail entity, where malfunctioning of a receiving display terminal is identified.

FIG. 5 exemplarily illustrates a flowchart comprising the steps for dynamically managing prices of multiple items in a retail entity, where pricing data for items is transmitted to receiving display terminals via mobile transmission devices.

FIG. 6 exemplarily illustrates a flowchart comprising the steps for dynamically managing prices of perishable items in a retail entity.

FIG. 7 exemplarily illustrates a flowchart comprising the steps for dynamically managing prices of perishable items in a retail entity, where pricing data for the perishable items is transmitted to receiving display terminals via mobile transmission devices.

FIG. 8 exemplarily illustrates a flowchart comprising the steps for remotely transmitting pricing data to receiving display terminals via mobile transmission devices at multiple branches of a retail entity.

FIG. 9 exemplarily illustrates a system for dynamically managing prices of multiple items in a retail entity.

FIG. 10 exemplarily illustrates a hardware architecture of a price management system for dynamically managing prices of multiple items in a retail entity.

### DETAILED DESCRIPTION OF THE INVENTION

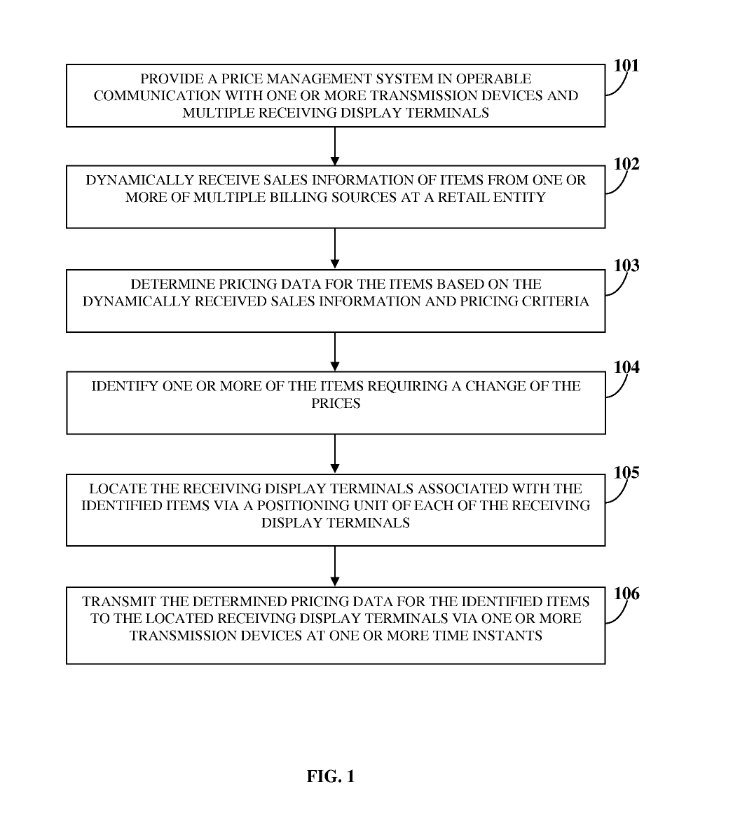

FIG. 1 illustrates a method for dynamically managing prices of multiple items in a retail entity. As used herein, “retail entity” refers, for example, to a business, an organization, an establishment, etc., that provides items, for example, products for sale, where a majority of the items are sold directly to end users of the items. A retail entity is, for example, a supermarket, a department store, a general store, a discount store, a shopping mall, a motel, a fuel station, etc. The method disclosed herein provides 101 a price management system comprising at least one processor, in operable communication with one or more transmission devices and multiple receiving display terminals. The transmission devices comprise, for example, electronic devices operating in tandem for transmitting signals comprising data locally or remotely to each of the receiving display terminals. The transmission devices transmit the signals, for example, in a sequence, in bulk, in intermittent intervals, in predefined periods, etc., to the receiving display terminals. In an embodiment, the transmission devices are positioned inside the premises of the retail entity. In another embodiment, the transmission devices are positioned outside the premises of the retail entity. In another embodiment, the transmission devices are positioned at a remote location away from the retail entity.

The receiving display terminals are configured as independent, for example, free standing electronic price display terminals, positioned in different target locations inside or outside the retail entity. The receiving display terminals are, for example, electronic display boards, electronic billboards, kiosks, electronic signage stands, display towers, etc., on highways, in motels, in shopping malls, in fuel stations, at trade fairs, etc., displaying information of an item, a price of the item, an image of the item, a message associated with the item, etc. In an embodiment, the price management system operably communicates with a single receiving display terminal, for example, an electronic display board positioned on a tower at a fuel or gas station. Each of the receiving display terminals is configured with a positioning unit, for example, a global positioning system (GPS) receiver, and is positioned at the retail entity or in a remote location. The positioning unit in each of the receiving display terminals enables the price management system to locate the receiving display terminals for correctly transmitting changed prices of the items to the correct receiving display terminals. For example, the price management system transmits a changed price of a piece of merchandize to a specific receiving display terminal that is displaying information about the merchandize.

A geographical location of a receiving display terminal serves as a destination location of an item, where the receiving display terminal displays information on the item. The price management system uses the destination location of the item for transmitting dynamic price changes associated with the item to the receiving display terminal associated with the item. Each of the receiving display terminals is configured with a processor, for example, a built-in electronic chip, and a unique identification code. The built-in electronic chip of each of the receiving display terminals receives the pricing data from the transmission devices. The unique identification code is used to identify the receiving display terminal. In an embodiment, the unique identification code of a receiving display terminal associated with an item is linked to an identification code, for example, a stock keeping unit (SKU) of the associated item. The price management system stores associations between the items and their corresponding receiving display terminals in a price management database. On identification of the receiving display terminal by its unique identification code and geographical location, a receiving display terminal can receive signals that the transmission devices transmit and target to this specific receiving display terminal, similar to how a cell phone uses a unique contact number for receiving call signals and/or message signals. In an embodiment, users, for example, maintenance personnel at the retail entity manually manage the transmission devices and the receiving display terminals. In another embodiment, the management of the transmission devices and the receiving display terminals is automated.

The price management system dynamically receives 102 sales information of the items from one or more of multiple billing sources at the retail entity, for example, via a communication network such as a wired communication network or a wireless communication network. As used herein, “billing sources” refers to point of sale systems that complete a retail transaction by processing payment of items and store data associated with billing and payment of the items. The billing sources comprise, for example, checkout counters, electronic cash registers, self-checkout kiosks, etc. The billing sources are operably linked to the price management system for transmitting sales information stored at the billing sources to the price management system. In an embodiment, the billing sources are operably linked to the price management system via a wired communication network. In another embodiment, the billing sources are operably linked to the price management system via a wireless communication network.

In an embodiment, the price management system periodically monitors the billing sources via a communication network for receiving the sales information. The sales information comprises, for example, an identification code of each of the items such as a stock keeping unit (SKU) of an item, an original price of each of the items, an expiration date of each of the items, an image of each of the items, a quantity of each of the items processed by the billing sources in a predefined time period, an identification code of each of the receiving display terminals associated with each of the items, feedback sales data, etc. As used herein, “feedback sales data” refers to sales data received from the billing sources after the prices of the items are changed, when compared to original prices of the items. The feedback sales data comprises, for example, a changed volume of sale of an item for a predefined time period, a changed rate of sale of a predefined volume of an item, etc., after the price of the item changes.

The price management system periodically receives the sales information from one or more billing sources manually or via one or more automated devices. The price management system analyzes and processes the received sales information for monitoring purposes. The price management system initiates a retail price change determination based on the received sales information. In an embodiment, the price management system determines a sales pattern associated with each of the items based on a change of sale of each of the items with a change of prices extracted from the dynamically received sales information for determining the pricing data for the items. The price management system monitors the change of sale of the items with the change of prices of the items using the feedback sales data extracted from the dynamically received sales information for determining the pricing data to improve inventory management at the retail entity. In an embodiment, the billing sources operably linked to the price management system tabulate changes made to the prices and record the sales pattern with the price changes. Changing the prices of the items at target locations, that is, at the receiving display terminals at the retail entity, determining the effects on sales at the billing sources after the prices of the items change, and determining whether to change or not to change the prices further based on the sales pattern is an iterative process. The price management system iteratively changes prices of items, determines a sales pattern by monitoring the effects on sales, and determines whether to change the prices further based on the determined sales pattern. The price management system subsequently makes decisions for managing and updating the inventory at the retail entity, for example, by managing item purchases and a stock of items at the retail entity.

The price management system determines 103 pricing data for the items based on the dynamically received sales information and pricing criteria. In an embodiment, the price management system determines the pricing data based on market research, where sales information of the items is received from one or more competitors of the retail entity in one or more geographical locations. This sales information can be obtained from multiple sources comprising, for example, a website of a competitor retail entity, billing sources of the competitor retail entity, etc. The pricing data comprises, for example, an identification code of each of the items, a name of each of the items, an updated price of each of the items, an image of each of the items, one or more messages associated with each of the items, etc. The messages comprise, for example, promotional messages, advertisement messages, brand messages, etc., received from the retail entity. The pricing criteria comprise, for example, a type of an item such as a perishable item or a non-perishable item, an expiration date of the item, and a quantity of the item in an inventory of the retail entity.

In an example, the price management system determines an updated price for an item based on whether the item is a perishable item or a non-perishable item. If the item is a perishable item whose expiration date is fast approaching, the price management system determines a lower price for the item by reducing the original price of the item. In another example, if the quantity of an item is large, the price management system determines a lower price for the item by reducing the original price of the item to quickly exhaust the item from shelves of the retail entity. In another example, the price management system determines an updated price for an item based on feedback sales data received from one or more billing sources at the retail entity. In this example, the price management system monitors the change of sales of the items with the change of prices and determines whether to increase the price of the item, reduce the price of the item, or retain the original price of the item based on the effect on sales of the items by previous price changes. In another example, the price management system includes a message such as “4^{th} of July special discount price”, “Valentine's day sale”, etc., to be displayed along with the updated price of an item.

In an embodiment, the price management system receives one or more inputs from management staff at the retail entity and re-determines the pricing data based on the received inputs, for example, via a communication network. The inputs from management staff comprise, for example, a lower limit for the updated price of each of the items, a higher limit for the updated price of each of the items, a confirmation on the updated price of each of the items, a message associated with each of the items, etc. The price management system identifies 104 one or more of the items requiring a change of the prices based on the determined pricing data. Consider an example where the price management system initiates a retail price change determination for items sold in the month of January at a retail entity. The price management system receives sales information of the items for the month of January from checkout counters at the retail entity. The received sales information comprises, for example, stock keeping units (SKUs) of the items, original prices of the items, and the quantity of each of the types of the items sold for the month of the January. Based on this sales information and pricing criteria, for example, a type of each of the items such as perishable or non-perishable, the price management system determines the pricing data comprising an updated price for each of the items. For example, if a perishable item, whose expiration date is fast approaching, is present in a large quantity in an inventory of the retail entity and is not being sold in a large volume, then the price management system updates the original price of the item to a price lower than the original price. The price management system determines the SKUs of the items whose original prices were updated by the price management system to identify the items in the inventory of the retail entity whose original prices need to be changed.

The price management system locates 105 the receiving display terminals associated with the identified items via the positioning unit of each of the receiving display terminals. In an embodiment, the positioning unit of each of the receiving display terminals is in operable communication with a satellite system, for example, a global positioning system (GPS) for allowing the price management system to locate the receiving display terminals associated with the identified items. In an embodiment, the price management system uses the identification codes, for example, stock keeping units (SKUs) of the identified items to determine the unique identification codes of the receiving display terminals associated with the identified items. The unique identification codes identify the associated receiving display terminals. In an embodiment, the price management system locates a receiving display terminal by transmitting signals comprising the unique identification code of the receiving display terminal to a low orbiting satellite system and beaming signals from the low orbiting satellite system to the positioning unit of the receiving display terminal. On identifying the receiving display terminal from the unique identification code, the low orbiting satellite system beams signals to the positioning unit of the receiving display terminal to enable the positioning unit to determine the location of the receiving display terminal and transmit the location of the receiving display terminal to the price management system. In an embodiment, the price management system retrieves the locations of the receiving display terminals associated with the identified items directly from the positioning units of the receiving display terminals.

The price management system transmits 106 the determined pricing data for the identified items, to the located receiving display terminals via one or more transmission devices at one or more time instants. The price management system configures one or more time instants for changing the prices of the identified items based on the dynamically received sales information. The price management system uses the received sales information as a determining factor for adjusting the prices of the items at the configured time instants, for example, at a specific time of the day, a specific time of the week, a specific day of the week, a specific period of the month, a specific period of the year, etc. For example, the price management system adjusts the prices of items such as barbeque charcoal briquettes to be lower during winters in Minnesota, but not be lower in Florida. The price management system initially transmits the determined pricing data of the identified items to the transmission devices, for example, via a communication network such as a wired communication network or a wireless communication network. The transmission devices then transmit the determined pricing data to the located receiving display terminals via one or more communication modes, for example, wired communication modes, wireless communication modes, or any combination thereof. The communication modes comprise, for example, via radio frequency identification (RFID), microwaves, satellite, laser, infrared, a wireless mode such as WiFi® of Wi-Fi Alliance Corporation, gamma-rays, X-rays, a wired connection such as an electrical low-voltage wired connection, a cable connection, a global positioning system (GPS), a mobile tower, a mobile phone, a handheld device with or without sensors, image recognition methods, etc.

The located receiving display terminals display the determined pricing data, for example, a name of an item, a stock keeping unit (SKU) of the item, and the updated retail price of the item. The located receiving display terminals also display images of the items, for example, brand images such as a logo image for Wrangler® jeans of Wrangler Apparel Corp., the Apple logo of Apple Inc., for the iPhone® of Apple Inc., etc., for enabling end users such as retail buyers to identify the items with ease. Displaying the brand images on the receiving display terminals enables the end users to identify and/or locate a specific item amidst multiple items. Retail entities can generate revenue from the brand companies for displaying the brand images of the brand companies on the receiving display terminals. In an embodiment, the price management system configures the determined pricing data in one or more of multiple languages, for example, Spanish, Mandarin, Russian, Arabic, etc., for a selective display of the determined pricing data in those languages on the located receiving display terminals. In an embodiment, the price management system selects a default language for display of the determined pricing data based on the geographic location of the receiving display terminal. For example, if the receiving display terminal associated with an identified item is located in China, the price management system configures the updated price of the identified item in Mandarin for display on the receiving display terminal.

The price management system disclosed herein manages the prices of the items by changing the original prices along with the messages associated with the items. The price management system manages the prices in one or more ways comprising, for example, remotely from a central location, directly at a target location, that is, the retail entity, individually for multiple items positioned at each of multiple locations of a retail entity or a retail entity chain, simultaneously in a group of locations such as in multiple locations of the retail entity chain, city-wise or state-wise for an item, instantly, at regular intervals of hours of a day, or days of the week, weeks of the month, months of the year, etc. The price management system enables retailers or merchants that own the retail entity to manage complex pricing of items to attract customers or end users and boost sales of the retail entity by automatically changing the prices with minimum human involvement and minimum manual intervention. The price management system enables the customers to compare values defined by the displayed prices of items across brands via the receiving display terminals.

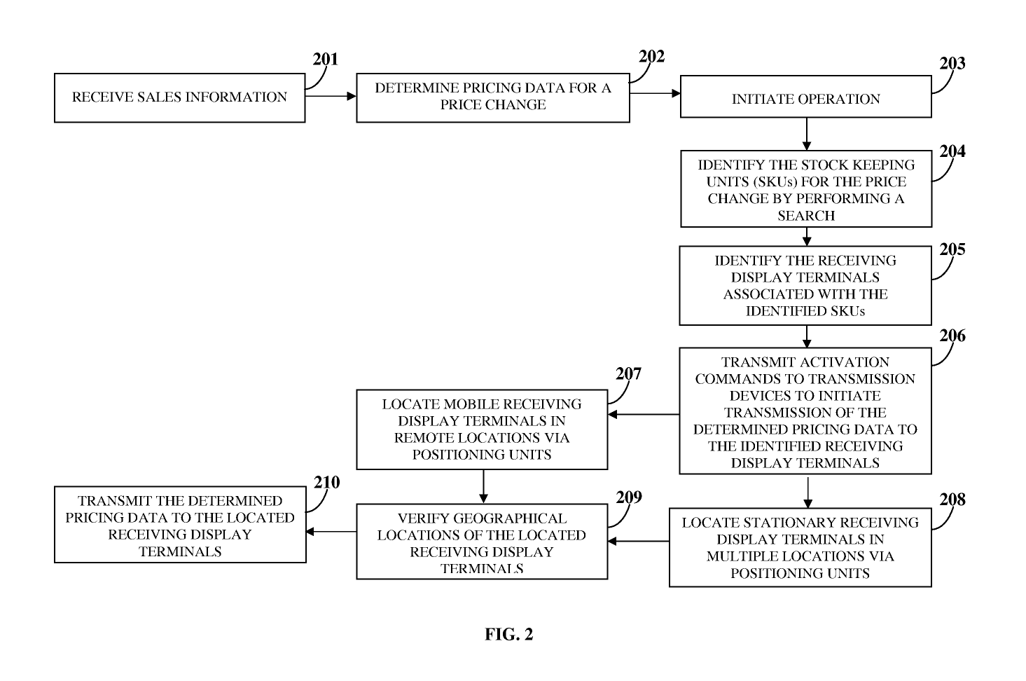

FIG. 2 exemplarily illustrates a flowchart comprising the steps for dynamically managing prices of multiple items in a retail entity, where receiving display terminals at one or more of multiple locations are located and pricing data is transmitted to the located receiving display terminals via one or more transmission devices. The price management system communicates with a market research unit at a retail entity and dynamically receives 201 sales information associated with multiple items from the market research unit and one or more billing sources at the retail entity. The sales information comprises, for example, a stock keeping unit (SKU) associated with each of the items, an original price of each of the items, a quantity of each of the items sold in a predefined time period, etc. The price management system determines 202 pricing data comprising updated prices of one or more items to indicate a price change for the items based on an analysis of the received sales information. The price management system maintains a list of all the items with their respective SKUs, names, original prices, and updated prices in the price management database. In an embodiment, the price management system is configured to reside on one or more servers, for example, a central price management server in operable communication with a transmission server for transmitting the pricing data to one or more transmission devices at predefined time instants or intervals. In this embodiment, the price management system initiates 203 a computer service operation on the central price management server for identifying the items requiring a price change.

The price management system identifies 204 the stock keeping units (SKUs) of the items that require a price change, for example, by performing a search in the price management database, comparing the original prices of the items obtained from the received sales information with the updated prices of the items, and selecting the SKUs of the items that show a change in the prices. The price management system identifies 205 the receiving display terminals associated with the identified SKUs, that is, identifies the receiving display terminals that are configured by the retail entity to display information associated with the identified items. In an embodiment, the price management system identifies the receiving display terminals by identifying the unique identification codes of the receiving display terminals that are linked to the identified SKUs of the items in the price management database. The price management system transmits 206 activation commands to the transmission devices to initiate transmission of the determined pricing data to the identified receiving display terminals. In an embodiment, the price management system triggers the transmission server to transmit the activation commands to the transmission devices at preconfigured time instants.

In an embodiment, the receiving display terminals are configured as mobile receiving display terminals. In another embodiment, the receiving display terminals are configured as stationary receiving display terminals. Each of the receiving display terminals are configured with a positioning unit, for example, a global positioning system (GPS) receiver. The price management system locates 207 mobile receiving display terminals positioned at one or more remote locations via their respective positioning units. The price management system locates 208 multiple stationary receiving display terminals positioned in multiple locations at the retail entity via their respective positioning units. The price management system verifies 209 the geographical locations of each of the located mobile receiving display terminals and each of the located stationary receiving display terminals. The price management system transmits 210 the determined pricing data comprising, for example, the updated prices of the identified items, one or more messages associated with the item, an image of the item, etc., to the located mobile receiving display terminals and the located stationary receiving display terminals via the transmission devices.

Consider an example where the price management system communicates with a market research unit of a retail store and receives sales information of multiple items sold at the retail store from the billing sources at the retail store. The received sales information comprises, for example, stock keeping units (SKUs) of the items, the linked unique identification codes (UICs) of the receiving display terminals configured to display information about the items, the original prices of the items sold at the retail store, expiration dates of the items, and sales volume of the items. The price management system stores the received sales information in a table of the price management database as shown below:

| | Receiving | | Original | | Sales Volume |
|---|---|---|---|---|---|
| | Display | | Prices of | Expiration | (Number of |
| | Terminal | Item | Items | Date | items |
| Item Name | UICs | SKUs | ($) | (MM/DD/YYYY) | sold/month) |
| Farm Fresh | RDT01 | SKU101 | 2 | 01/30/2015 | 75 |
| Milk | | | | | |
| Half n Half | RDT02 | SKU102 | 1 | 01/30/2015 | 250 |
| Milk | | | | | |
| Soya Milk | RDT03 | SKU103 | 4 | 02/28/2015 | 50 |
| Medium Range | RDT11 | SKU111 | 2 | 02/10/2015 | 100 |
| Eggs | | | | | |
| Free Range | RDT12 | SKU112 | 2.5 | 01/25/2015 | 100 |
| Eggs | | | | | |
| Organic Eggs | RDT13 | SKU113 | 6 | 02/01/2015 | 50 |

The price management system analyzes the received sales information and determines an updated price for two of the items, for example, farm fresh milk and free range eggs that have recently witnessed a dip in the sales and/or are approaching their respective expiration dates. The original prices for farm fresh milk and free range eggs are $2 and $2.5 respectively. The price management system updates these prices to $1.5 for farm fresh milk and $1.99 for free range eggs and stores the updated prices in the price management database, while maintaining the original prices of the other items in the price management database as shown in the table below:

| | | | | | | Sales |
|---|---|---|---|---|---|---|
| | Receiving | | | | | Volume |
| | Display | | Original | Updated | Expiration | (Number of |
| Item | Terminal | Item | Prices of | Prices of | Date | items |
| Name | UICs | SKUs | Items ($) | Items ($) | (DD/MM/YYYY) | sold/month) |
| Farm | RDT01 | SKU101 | 2 | 1.5 | 01/30/2015 | 75 |
| Fresh | | | | | | |
| Milk | | | | | | |
| Half n | RDT02 | SKU102 | 1 | 1 | 01/30/2015 | 250 |
| Half | | | | | | |
| Milk | | | | | | |
| Soya | RDT03 | SKU103 | 4 | 4 | 02/28/2015 | 50 |
| Milk | | | | | | |
| Medium | RDT11 | SKU111 | 2 | 2 | 02/10/2015 | 100 |
| Range | | | | | | |
| Eggs | | | | | | |
| Free | RDT12 | SKU112 | 2.5 | 1.99 | 01/25/2015 | 100 |
| Range | | | | | | |
| Eggs | | | | | | |
| Organic | RDT13 | SKU113 | 6 | 6 | 02/01/2015 | 50 |
| Eggs | | | | | | |

To identify the stock keeping units (SKUs) of the items with updated prices, the price management system queries the price management database to receive the SKUs of the items that have a price difference between the original prices and the updated prices. The price management system receives a result set comprising, for example, SKU101 for the farm fresh milk and SKU112 for the free range eggs, that represent the items with a price difference between the original prices and the updated prices. The price management system identifies the SKUs, for example, SKU101 and SKU112 for the farm fresh milk and the free range eggs respectively, by comparing the original price of each of the items obtained from the received sales information with the updated price of each of the items, and selecting the SKUs of the items that show a change in the prices. The price management system identifies the unique identification codes (UICs) of the receiving display terminals RDT01 and RDT12 that are linked with SKU101 and SKU112 respectively, based on the received sales information stored in the price management database. The price management system uses the identified SKUs, for example, SKU101 and SKU112 for identifying the receiving display terminals configured to display information about the items with the SKUs, for example, SKU101 and SKU112, in order to reflect a price change for these items on the identified receiving display terminals having UICs, namely, RDT01 and RDT12 respectively. The price management system transmits activation commands to one or more transmission devices to transmit the determined updated prices $1.5 for farm fresh milk and $1.99 for free range eggs to the receiving display terminals identified by RDT01 and RDT12 respectively. In this example, RDT01 is a mobile receiving display terminal positioned at a remote location and RDT12 is a stationary receiving display terminal positioned inside the retail store. The price management system locates the receiving display terminals represented by RDT01 and RDT12 via their respective positioning units and verifies their geographical locations. In an embodiment, the price management system performs this verification by receiving a confirmation from the retail store ensuring that the located receiving display terminals represented by RDT01 and RDT12 belong to the retail store and display information associated with the items represented by SKU101 and SKU112 respectively. The price management system transmits the updated prices to the located receiving display terminals represented by RDT01 and RDT12 via the transmission devices. The located receiving display terminals represented by RDT01 and RDT12 display the updated prices $1.5 for farm fresh milk and $1.99 for free range eggs on their respective graphical user interfaces (GUIs).

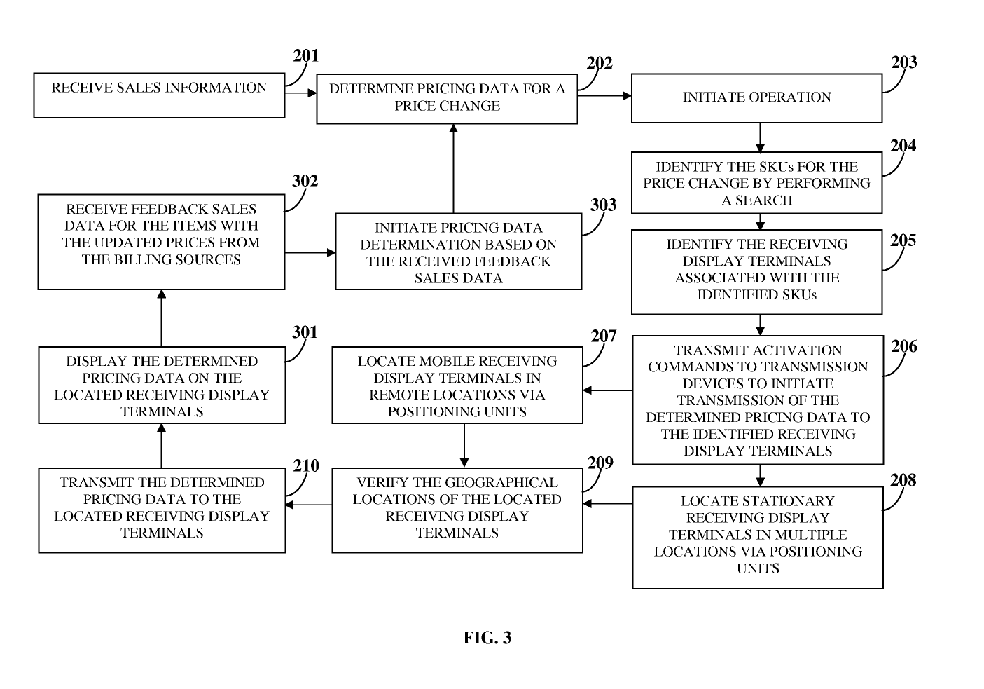

FIG. 3 exemplarily illustrates a flowchart comprising the steps for dynamically managing prices of multiple items in a retail entity, where a sales pattern associated with an item is determined for determining pricing data of the item. The price management system communicates with a market research unit at a retail entity and dynamically receives 201 sales information associated with multiple items from the market research unit and one or more billing sources at the retail entity. The price management system determines 202 pricing data comprising updated prices of one or more items to indicate a price change for the items based on an analysis of the received sales information. The price management system initiates 203 a computer service operation for identifying the items requiring a price change. The price management system identifies 204 the stock keeping units (SKUs) of the items that require a price change, for example, by performing a search in the price management database, comparing the original prices of the items obtained from the received sales information with the updated prices of the items, and selecting the SKUs of the items that show a change in the prices. The price management system identifies 205 the receiving display terminals associated with the identified SKUs, that is, identifies the receiving display terminals that are configured by the retail entity to display information associated with the identified items. The price management system transmits 206 activation commands to one or more transmission devices to initiate transmission of the determined pricing data to the identified receiving display terminals. The price management system locates 207 multiple mobile receiving display terminals positioned at one or more remote locations via their respective positioning units. The price management system locates 208 multiple stationary receiving display terminals positioned in multiple locations at the retail entity via their respective positioning units. The price management system verifies 209 the geographical locations of each of the located mobile receiving display terminals and each of the located stationary receiving display terminals. The price management system transmits 210 the determined pricing data comprising, for example, an updated price of an item, one or more messages associated with the item, an image of the item, etc., to the located mobile receiving display terminals and the located stationary receiving display terminals via the transmission devices.

The located receiving display terminals display 301 the determined pricing data on their respective graphical user interfaces (GUIs). The price management system operably communicates with the billing sources at the retail entity. The billing sources monitor, receive, and store sales information comprising feedback sales data of the items with a price change to facilitate determination of a sales pattern associated with each of the items. The price management system receives 302 the feedback sales data for the items with the updated prices from the billing sources. The price management system continuously monitors the billing sources of the retail entity for receiving the feedback sales data. The price management system initiates 303 a pricing data determination based on the received feedback sales data and iteratively performs the steps 202 to 210, 301, 302, and 303. The feedback sales data is therefore a determining factor for adjusting or modifying the updated prices of items at one or more preconfigured time instants, and improving inventory management.

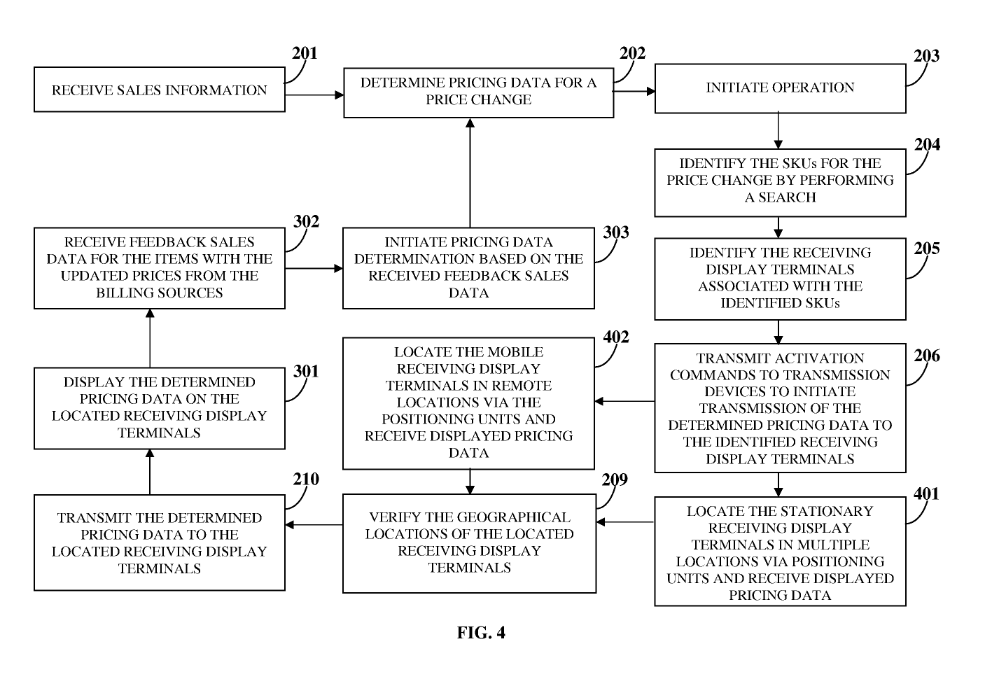

FIG. 4 exemplarily illustrates a flowchart comprising the steps for dynamically managing prices of multiple items in a retail entity, where malfunctioning of a receiving display terminal is identified. In an embodiment, to identify malfunctioning receiving display terminals, the price management system transmits activation commands to one or more transmission devices to transmit signals to the receiving display terminals and receive a feedback signal from each of the receiving display terminals. The transmission devices operably communicate with the receiving display terminals for transmitting and receiving signals. This two-way signaling communication between the transmission devices and the receiving display terminals facilitates verification of the updated prices being displayed at the receiving display terminals and identification of the malfunctioning receiving display terminals. If the transmission devices do not receive a feedback signal from a receiving display terminal, the price management system determines the malfunctioning of that receiving display terminal. The receiving display terminals also transmit display information comprising, for example, the updated price, the messages, etc., being displayed on the receiving display terminals to the transmission devices for verification by the price management system.

As exemplarily illustrated in FIG. 4, the price management system communicates with a market research unit of a retail entity and dynamically receives 201 sales information associated with multiple items from the market research unit and one or more billing sources at the retail entity. The price management system determines 202 pricing data comprising updated prices of one or more items to indicate a price change for the items based on an analysis of the received sales information. The price management system initiates 203 a computer service operation for identifying the items requiring a price change. The price management system identifies 204 the stock keeping units (SKUs) of the items that require a price change, for example, by performing a search in the price management database, comparing the original prices of the items obtained from the received sales information with the updated prices of the items, and selecting the SKUs of the items that show a change in the prices. The price management system identifies 205 the receiving display terminals associated with the identified SKUs, that is, identifies the receiving display terminals that are configured by the retail entity to display information associated with the identified items. The price management system transmits 206 activation commands to the transmission devices to initiate transmission of the determined pricing data to the identified receiving display terminals.

The price management system locates 401 multiple stationary receiving display terminals positioned in multiple locations in the retail entity via their respective positioning units and receives displayed pricing data comprising, for example, an updated price of an item, from each of the stationary receiving display terminals. The price management system locates 402 multiple mobile receiving display terminals positioned at one or more remote locations via their respective positioning units and receives displayed pricing data from each of the mobile receiving display terminals. The price management system verifies 209 the geographical locations of each of the located mobile receiving display terminals and each of the located stationary receiving display terminals. The price management system transmits 210 the determined pricing data to the located mobile receiving display terminals and the located stationary receiving display terminals via the transmission devices. The located receiving display terminals display 301 the determined pricing data on their respective graphical user interfaces (GUIs). The price management system receives 302 the feedback sales data for the items with the updated prices from the billing sources. The price management system initiates 303 a pricing data determination based on the received feedback sales data and iteratively performs the steps 202 to 206, 401, 402, 209, 210, 301, 302, and 303.

The price management system identifies malfunctioning of the receiving display terminals based on a comparison of the displayed pricing data received from the receiving display terminals with the determined pricing data transmitted by the transmission devices. The receiving display terminals transmit the displayed pricing data to the price management system via the transmission devices for facilitating the comparison. For receiving the displayed pricing data from the receiving display terminals, the transmission devices transmit a signal in real time to each of the receiving display terminals, requesting for the pricing data that is being displayed on each of the receiving display terminals. The transmission devices receive a feedback signal comprising the displayed pricing data from each of the receiving display terminals. Failure to receive the displayed pricing data from the receiving display terminals indicates malfunctioning of the receiving display terminals. The price management system generates and transmits a notification configured to indicate the malfunctioning of the receiving display terminals to the retail entity, for example, to maintenance staff of the retail entity. On receiving the notification, the maintenance staff at the retail entity can repair or replace the malfunctioning receiving display terminals.

On receiving the feedback signals from the receiving display terminals via the transmission devices, the price management system compares the displayed pricing data of an item with the determined pricing data of the item to verify an accurate display of the determined pricing data and operation of the receiving display terminals. The price management system therefore confirms the new price changes associated with the items. In an embodiment, the price management system also verifies the messages associated with the items and the images of the items being displayed on the located receiving display terminals from the feedback signals received from the receiving display terminals. In an embodiment, the price management system identifies malfunctioning of the transmission devices by transmitting activation commands to the transmission devices, and receiving a confirmation of receipt of the transmitted activation commands from the transmission devices. Failure to receive the confirmation of receipt of the transmitted activation commands from the transmission devices indicates malfunctioning of the transmission devices. The price management system generates and transmits a notification configured to indicate the malfunctioning of the transmission devices to the retail entity, for example, to maintenance staff of the retail entity. On receiving the notification, the maintenance staff at the retail store can repair or replace the malfunctioning transmission devices.

In an embodiment, the price management system identifies malfunctioning of the receiving display terminals by receiving one or more images of the receiving display terminals displaying the pricing data from one or more image capture devices positioned proximal to the receiving display terminals and analyzing the received images. In this embodiment, one or more image capture devices, for example, a digital camera, a closed circuit television (CCTV) camera, etc., are positioned proximal to the receiving display terminals inside or outside the retail entity. The price management system identifies the malfunctioning receiving display terminals from one or more images of the receiving display terminals, captured by the image capture devices. If the captured images show inaccurate pricing data, inaccurate images, inaccurate messages, etc., being displayed on the receiving display terminals, the price management system identifies those receiving display terminals as malfunctioning receiving display terminals. The price management system generates and transmits a notification configured to indicate the identified malfunctioning receiving display terminals to the retail entity, for example, to maintenance staff of the retail entity.

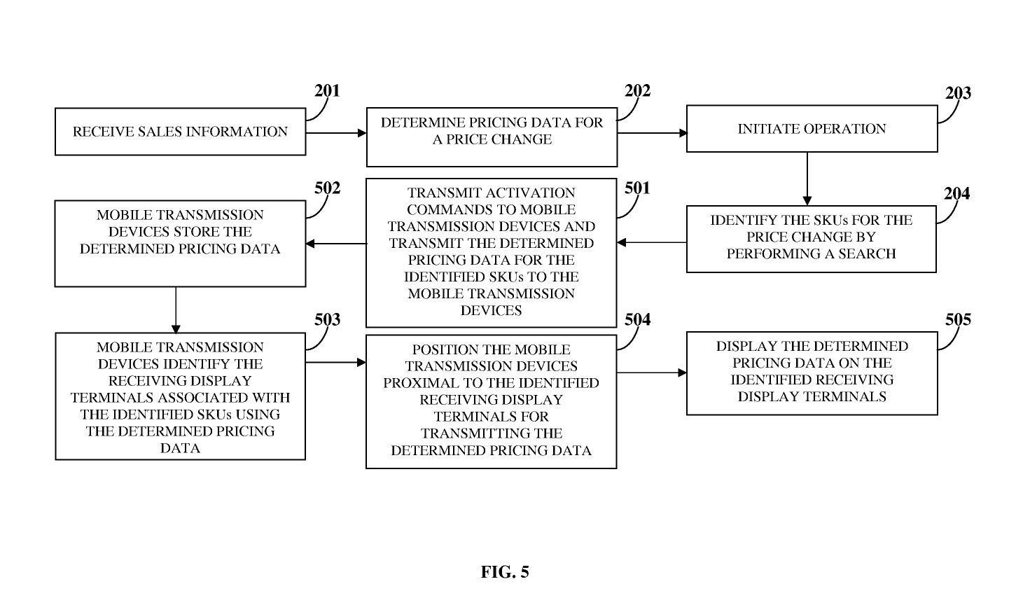

FIG. 5 exemplarily illustrates a flowchart comprising the steps for dynamically managing prices of multiple items in a retail entity, where pricing data for items is transmitted to receiving display terminals via mobile transmission devices. The price management system communicates with a market research unit of a retail entity and dynamically receives 201 sales information associated with multiple items from one or more multiple billing sources at the retail entity. The price management system determines 202 pricing data comprising updated prices of one or more items to indicate a price change for the items based on an analysis of the received sales information. The price management system initiates 203 a computer service operation for identifying the items requiring a price change. The price management system identifies 204 the stock keeping units (SKUs) of the items that require a price change, for example, by performing a search in the price management database, comparing the original prices of the items obtained from the received sales information with the updated prices of the items, and selecting the SKUs of the items that show a change in the prices. In an embodiment, the transmission devices are configured as mobile transmission devices, for example, mobile phones, personal digital assistants, tablet computing devices, handheld computing devices, visual aid devices, etc. The mobile transmission devices can be used by management staff of a retail entity, inside or outside the retail entity. The mobile transmission devices are configured to transmit the determined pricing data to the receiving display terminals when positioned proximal to the receiving display terminals. The price management system transmits 501 activation commands to the mobile transmission devices and transmits the determined pricing data for the identified SKUs to the mobile transmission devices. The mobile transmission devices store 502 the determined pricing data in their memory units.

The price management system employs a mobile transmission device, for example, a mobile phone, a personal digital assistant (PDA), a tablet computing device, etc., for transmitting the determined pricing data, when the receiving display terminals are positioned at physically inaccessible locations, for example, an obscure location, a blind zone, a distant location, etc., or when there is signal interference present at higher altitudes between the transmission devices and the receiving display terminals. As used herein, “blind zone” refers to an area that is within an operating range of a transmission device but has a weak or intermittent reception of transmitted signals. The mobile transmission devices identify 503 the receiving display terminals associated with the identified stock keeping units (SKUs) using the determined pricing data. In an embodiment, the management staff at a retail entity accesses the mobile transmission devices and receives and downloads the determined pricing data from the price management system. After receiving and storing the determining pricing data on the mobile transmission devices, the management staff positions 504 the mobile transmission devices proximal to the identified receiving display terminals for transmitting the determined pricing data to the identified receiving display terminals. The identified receiving display terminals receive and display 505 the determined pricing data on their respective graphical user interfaces (GUIs). The price management system updates the pricing data in real time on the mobile transmission devices. The mobile transmission devices are configured with features and functionalities of the transmission devices to identify and activate the updated prices on the receiving display terminals, when the mobile transmission devices are positioned in proximity to the receiving display terminals.

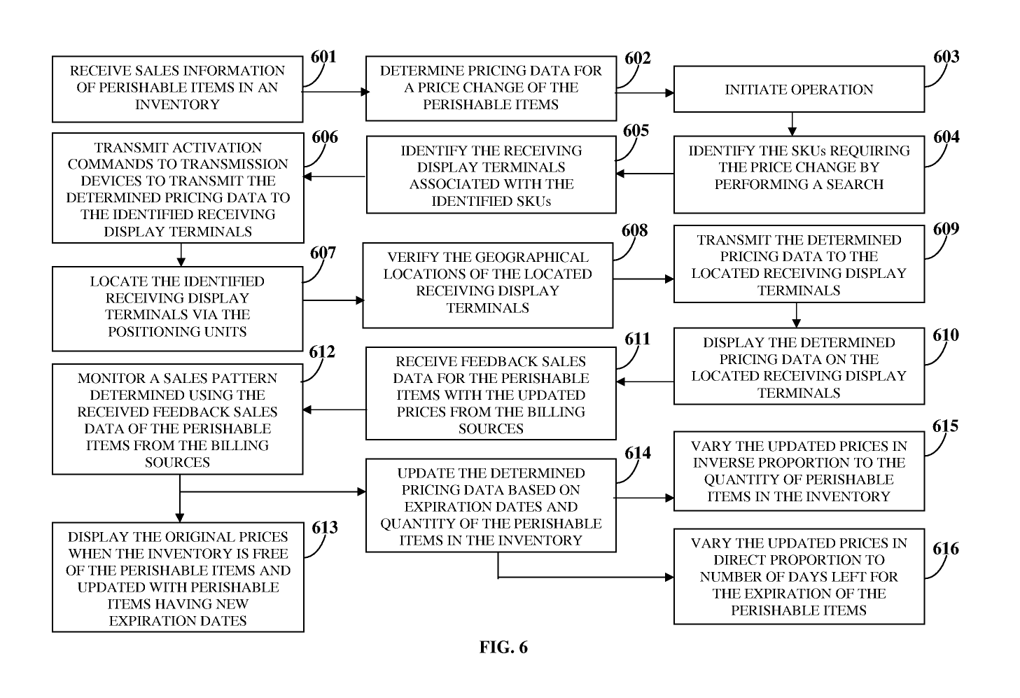

FIG. 6 exemplarily illustrates a flowchart comprising the steps for dynamically managing prices of perishable items in a retail entity. The price management system dynamically receives 601 sales information of perishable items in an inventory of the retail entity from one or more billing sources at the retail entity. The price management system is operably linked to the billing sources to track inventories of perishable items with expiration dates. The perishable items comprise, for example, milk, yogurt, juice, meat, fish, prepared food, bagels, cakes, donuts, medicines, etc., that have fixed expiration dates. The price management system schedules dynamic management of the prices of the perishable items that have fixed expiration dates in a frequent manner. The price management system schedules price changes for the perishable items with fixed expiration dates at one or more preconfigured time instants. The sales information comprises identification codes, for example, stock keeping units (SKUs) associated with each of the perishable items. The price management system links the SKUs for the perishable items with the expiration dates as producers of the perishable items may generate different SKUs having different batches with different expiration dates before shipping of the perishable items to the retail entity. The price management system determines 602 pricing data indicating a price change for the perishable items based on an analysis of the received sales information. The price management system initiates 603 a computer service operation for identifying perishable items requiring a price change.

The price management system identifies 604 the stock keeping units (SKUs) of the perishable items requiring a price change, for example, by performing a search in the price management database, comparing the original prices of the perishable items obtained from the received sales information with the updated prices of the perishable items, and selecting the SKUs of the perishable items that show a change in the prices. The price management system identifies 605 the receiving display terminals associated with the identified SKUs. The price management system transmits 606 activation commands to one or more transmission devices to transmit the determined pricing data to the identified receiving display terminals. The price management system locates 607 the identified receiving display terminals positioned, for example, proximal to locations of the perishable items, via the positioning units. The price management system verifies 608 the geographical locations of the located receiving display terminals. The price management system transmits 609 the determined pricing data to the located receiving display terminals via the transmission devices. In an embodiment, the transmission devices store the expiration dates of the perishable items to automatically determine discounted prices for the perishable items when the perishable items are present in large quantities in the inventory, and transmit the discounted prices to the located receiving display terminals. The located receiving display terminals display 610 the determined pricing data on their respective graphical user interfaces (GUIs).

The price management system receives 611 feedback sales data for the identified perishable items with the determined pricing data, for example, the updated prices, from the billing sources at the retail entity to update the updated prices of the perishable items. The price management system continuously monitors 612 a sales pattern determined for each of the identified perishable items using the received feedback sales data of the identified perishable items to identify the perishable items that further require a price change. The located receiving display terminals display 613 the original prices of the perishable items, when the inventory is free of the perishable items approaching their expiration dates and when the inventory is updated with perishable items having new expiration dates. The inventory is not replenished with perishable items having new expiration dates until the inventory having an old stock of the perishable items on the shelves of the retail entity is depleted.

The price management system updates 614 the determined pricing data of the perishable items based on the expiration dates and the quantity of the perishable items in the inventory. For example, the price management system adjusts the prices of the perishable items based on the expiration dates of the perishable items and inventory level. The price management system performs changes to the pricing data, for example, a markdown of the updated prices, by employing updated price modification logic that varies the updated prices, for example, based on the quantity of a perishable item in the inventory, the sales pattern of the perishable item on a particular day of a specific week of a specific month, the expiration date of a perishable item, etc. For example, the price management system varies 615 the updated prices of the perishable items in an inverse proportion to the quantity of perishable items in the inventory, and maintains the updated prices for an item with a high sales pattern and with a low quantity in the inventory as a low price indicates a low amount of profit. Furthermore, the price management system varies 616 the updated prices of the perishable items in a direct proportion to the number of days left for the expiration of the perishable items, that is, the markdown price accelerates as the expiration date approaches.

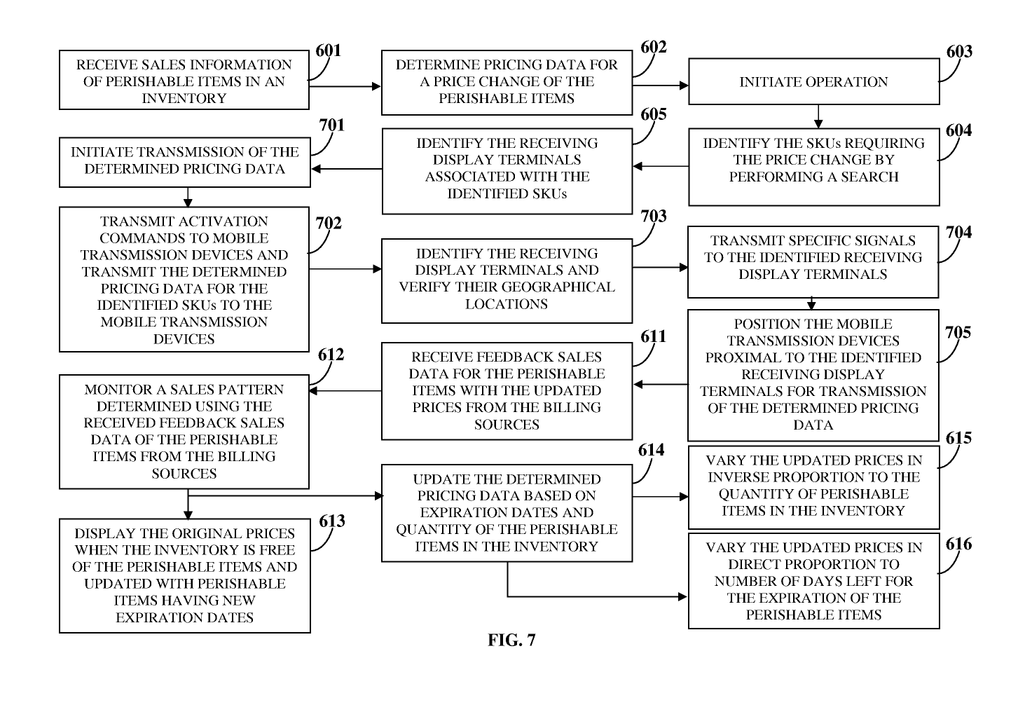

FIG. 7 exemplarily illustrates a flowchart comprising the steps for dynamically managing prices of perishable items in a retail entity, where pricing data for the perishable items is transmitted to receiving display terminals via mobile transmission devices. The price management system communicates with a market research unit of a retail entity and dynamically receives 601 sales information of perishable items in an inventory of the retail entity from one or more billing sources at the retail entity. The price management system determines 602 pricing data indicating a price change for the perishable items based on an analysis of the received sales information. The price management system initiates 603 a computer service operation for identifying the perishable items requiring a price change. The price management system identifies 604 the stock keeping units (SKUs) of the perishable items requiring a price change, for example, by performing a search in the price management database, comparing the original prices of the perishable items obtained from the received sales information with the updated prices of the perishable items, and selecting the SKUs of the perishable items that show a change in the prices. The price management system identifies 605 the receiving display terminals associated with the identified SKUs.

The price management system initiates 701 transmission of the determined pricing data to the mobile transmission devices. The price management system transmits 702 activation commands to the mobile transmission devices and transmits the determined pricing data for the identified SKUs to the mobile transmission devices. The mobile transmission devices identify the receiving display terminals and verify 703 the geographical locations of the identified receiving display terminals. The mobile transmission devices transmit 704 specific signals to the identified receiving display terminals and wait for feedback signals from the identified receiving display terminals. The mobile transmission devices are then positioned 705 proximal to the identified receiving display terminals for transmission of the determined pricing data to the identified receiving display terminals.

The price management system receives 611 feedback sales data for the identified perishable items with the determined pricing data, that is, the updated prices, from the billing sources at the retail entity to update the updated prices of the perishable items. The price management system continuously monitors 612 a sales pattern determined for each of the identified perishable items using the received feedback sales data of the perishable items to identify the perishable items that further require a price change. The located receiving display terminals display 613 the original prices of the perishable items, when the inventory is free of the perishable items approaching their expiration dates and when the inventory is updated with perishable items having new expiration dates. The price management system updates 614 the determined pricing data of the perishable items based on the expiration dates and the quantity of the perishable items in the inventory. For example, the price management system varies 615 the updated prices of the perishable items in an inverse proportion to the quantity of perishable items in the inventory, and maintains the updated prices for an item with a high sales pattern and with a low quantity in the inventory as a low price indicates a low amount of profit. Furthermore, the price management system varies 616 the updated prices in a direct proportion to the number of days left for the expiration of the perishable items, that is, the markdown price accelerates as the expiration date approaches.

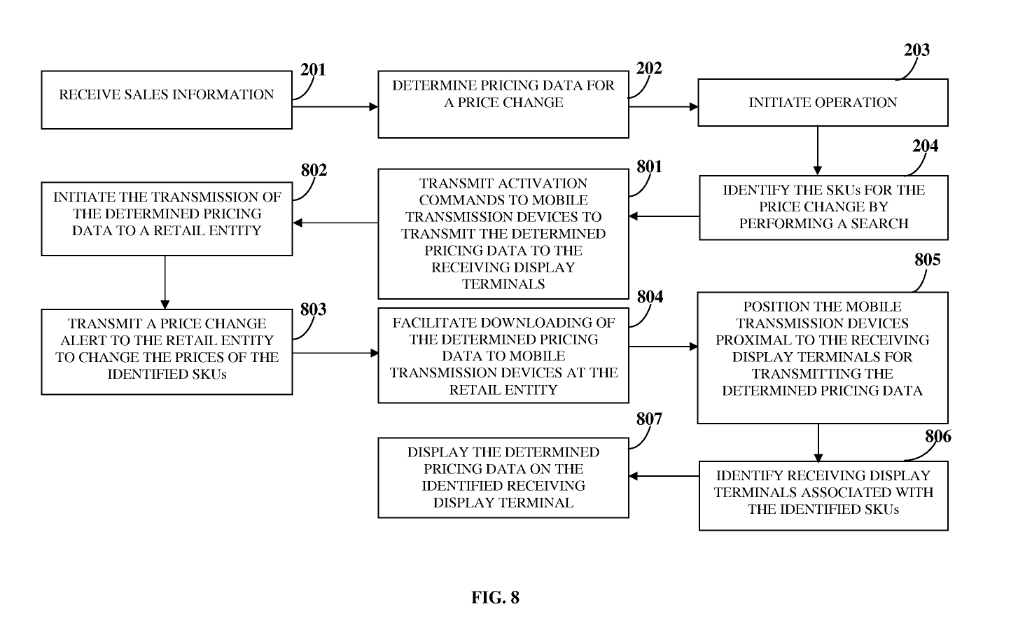

FIG. 8 exemplarily illustrates a flowchart comprising the steps for remotely transmitting pricing data to receiving display terminals via mobile transmission devices at multiple branches of a retail entity. The price management system communicates with a market research unit at a retail entity and dynamically receives 201 sales information associated with multiple items from the market research unit and one or more billing sources at the retail entity. The price management system determines 202 pricing data comprising updated prices of one or more items to indicate a price change for the items based on an analysis of the received sales information. The price management system initiates 203 a computer service operation for identifying the items requiring a price change. The price management system identifies 204 the stock keeping units (SKUs) of the items that require a price change, for example, by performing a search in the price management database, comparing the original prices of the items obtained from the received sales information with the updated prices of the items, and selecting the SKUs of the items with a change in the prices. The price management system identifies the receiving display terminals associated with the identified SKUs, that is, identifies the receiving display terminals that are configured by the retail entity to display information associated with the identified SKUs.

The price management system transmits 801 activation commands to the mobile transmission devices to transmit the determined pricing data to the identified receiving display terminals. The price management system initiates 802 the transmission of the determined pricing data to the branches of the retail entity, for example a branch office, a business client, a franchisee, etc. In an embodiment, the price management system initiates the transmission of the determined pricing data by uploading the determined pricing data to servers or computers of the branches of the retail entity. The price management system generates and transmits 803 a price change alert to the retail entity branches to change the prices of the identified stock keeping units (SKUs). For example, the price management system transmits a gas price change alert to gas stations, a room rate price change alert to motels, fast food special price change alerts to restaurants, discounted ticket price change alerts to a movie theater for a timely change of prices. On receiving the price change alert, the management staff at each of the branches of the retail entity branches downloads the determined pricing data from their servers to mobile transmission devices at the retail entity. Thus, the price management system 804 facilitates download of the determined pricing data to the mobile transmission devices. The management staff positions 805 the mobile transmission devices proximal to the receiving display terminals for transmitting the determined pricing data. The mobile transmission devices, using the determining pricing data, identify 806 the receiving display terminals associated with the identified SKUs for transmitting the determined pricing data. The mobile transmission devices transmit the determined pricing data of the identified SKUs to the identified receiving display terminals. The identified receiving display terminals display 807 the determined pricing data on their respective graphical user interfaces (GUI).

Consider an example where the price management system dynamically manages prices of items in a retail store. The price management system receives sales information for items from billing sources such as cash registers and checkout counters at the retail store. The price management system analyzes the received sales information to identify the items that are lagging in sales, that is, items that are not being sold as per the targets set by the retail store based on the inventory of the items at the retail store. The price management system identifies a furniture item, for example, a sofa set that has not been sold for over six months and requires a price change to facilitate sale of the sofa set. The price management system determines the original price of the sofa set is $400 from the received sales information. The price management system initiates a retail price change determination to reduce the price of the sofa set. The price management system determines an updated price of $350 for the sofa set in a bid to attract customers based on the received sales information about the sofa set, for example, number of sofa sets sold in a month or a year, and pricing criteria, for example, number of sofa sets available in the inventory, number of months that the sofa sets can remain in a saleable condition, etc. The price management system may receive one or more inputs from management staff of the retail store and further update the updated price based on the received inputs. The inputs comprise, for example, a lower limit or a higher limit on the sale price of the sofa set, a confirmation on the updated price, approval of the updated price, etc. In this example, the price management system receives approval on the updated price of $350 for the sofa set from the management staff at the retail store.

The price management system then identifies a stock keeping unit (SKU) of the sofa set in order to reflect a change of the price of the sofa set at the retail store. The price management system performs a search in the price management database, compares the original price of the sofa set from the received sales information with the updated price of the sofa set, and selects the SKU of the sofa set that shows a change in the price. The price management system identifies the SKU of the sofa set and determines the unique identification codes of the receiving display terminals associated with the sofa by querying the price management database. The price management system further identifies the receiving display terminals, for example, electronic price display units, associated with the SKU of the sofa set, positioned in various locations of the retail store using the determined unique identification codes. These receiving display terminals initially display the original price of the sofa set and information associated with the sofa set. The price management system locates each of the identified receiving display terminals via the positioning unit of each of the identified receiving display terminals by using, for example, a global positioning system (GPS) and the determined unique identification codes. The price management system transmits activation commands to the transmission devices to transmit the updated price of the sofa set to each of the located receiving display terminals. The transmission devices transmit the updated price of $350 for the sofa set to the located receiving display terminals. The located receiving display terminals display the updated price of $350 on their respective graphical user interfaces (GUIs). The receiving display terminals also display an image of the sofa set and a message, for example, a promotional message such as “sofa on sale” or “sofa so good” along with the updated price of the sofa set.

Consider another example where the price management system transmits activation commands to one or more mobile transmission devices, for example, cell phones, handheld personal digital assistants (PDAs), tablet computing devices, etc., to transmit the updated price of the sofa set to each of the located receiving display terminals, when the receiving display terminals are positioned at inaccessible locations, for example, at an obscure location, at a high altitude, or at a location where signal interference is present. In this example, the mobile transmission devices are positioned proximal to the receiving display terminals. The positioned mobile transmission devices transmit the updated price of $350 to the receiving display terminals via one or more communication modes, for example, radio frequency identification (RFID) signals, microwave signals, cable connections, etc. The price management system periodically monitors the billing sources at the retail store for receiving the sales information after an initial price change of the sofa set. The price management system determines a sales pattern associated with the sofa set based on a change of sale of the sofa set with the updated price. The price management system initiates a further retail price change determination based on the determined sales pattern, for example, by further reducing the updated price to $330 when the sales pattern shows no improvement in the sale of the sofa set, maintaining the updated price to $350 when the sales pattern shows an improvement in the sale of the sofa set, or by changing the price back to the original price of $380 when the inventory of the sofa sets is exhausted at the retail store and the retail store is in the process of importing new sofa sets.

Consider another example where the price management system dynamically manages prices of perishable items in a retail store. The price management system receives sales information of the perishable items sold at the retail store. The received sales information comprises, for example, the original price of each of the perishable items, expiration dates of each of the perishable items, quantity of each of the perishable items processed at the billing sources of the retail store for a fixed time period such as per day, per week, per month, an identification code of each of the receiving display terminals associated with each of the perishable items, etc. The price management system analyzes the received sales information to identify the perishable items that are lagging in sales and approaching their expiration dates. The price management system identifies a perishable item, for example, a loaf of bread that is lagging in sales, available in large quantities in the inventory at the retail store, and approaching the expiration date. The price management system determines the original price of the loaf of bread is $2.50 from the received sales information. The price management system initiates a retail price change determination to reduce the price of the loaf of bread based on the received sales information comprising, for example, bread inventory and the sales pattern of the loaf of bread on a specific day in a specific week of a specific month. If the bread is available in large quantities in the inventory and is approaching the expiration date, the price management system determines an updated price of $1.99 for the loaf of bread in a bid to attract customers.

The price management system then identifies a stock keeping unit (SKU) of the loaf of bread in order to reflect a change of the price of the loaf of bread at the retail store. The price management system performs a search in the price management database, compares the original price of the loaf of bread obtained from the received sales information with the updated price of the loaf of bread, and selects the SKU of the loaf of bread that shows a change in the price. The price management system identifies the SKU of the loaf of bread and determines the unique identification codes of the receiving display terminals associated with the loaf of bread by querying the price management database. The price management system further identifies the receiving display terminals associated with the SKU of the loaf of bread, positioned in various locations of the retail store using the determined unique identification codes. These receiving display terminals initially display the original price of the loaf of bread and information associated with the loaf of bread. The price management system locates the identified receiving display terminals via the positioning units of the identified receiving display terminals by using, for example, a global positioning system (GPS) and the determined unique identification codes. The price management system transmits the updated price of $1.99 for the loaf of bread to each of the located receiving display terminals via the transmission devices. The located receiving display terminals display the updated price of $1.99 on their respective graphical user interfaces (GUIs). For perishable items that are fast approaching their expiration dates, the price management system periodically monitors the billing sources to receive the sales information and determines the sales pattern after the updated price is transmitted to each of the receiving display terminals. The price management system determines this sales pattern at short intervals, for example, a predetermined number of times in a day or a week to avoid revenue losses due to expired perishable items. Based on the determined sales pattern, the price management system initiates the retail price change determination for further price changes.

Consider another example where the price management system identifies a malfunctioning receiving display terminal after locating the receiving display terminals. The transmission devices transmit a malfunction identification signal to each of the located receiving display terminals and receive a feedback signal indicating the price being displayed at each of the located receiving display terminals in real time. The price management system compares the price being displayed at each of the located receiving display terminals with the updated prices, for example, $350 for the sofa set or $1.99 for the loaf of bread. A mismatch in the comparison or a failure to receive the feedback signal indicating the price being displayed indicates a malfunctioning receiving display terminal. The price management system generates and transmits a notification to the retail store to indicate the malfunctioning receiving display terminal. On receiving the notification, the maintenance staff at the retail store can repair or replace the malfunctioning receiving display terminal.

Consider another example where the price management system generates and transmits an alert notification to branch offices or franchisees of a retail store chain that are positioned in remote locations, for example, franchises of Exxon® gas company of Exxon Mobil Corporation, fast food chains, wayside motels, etc., for changing the prices of the items that are found to be lagging in sales or approaching their expiration dates based on the sales information received from a central inventory of a main branch of the retail store chain. In this example, the price management system facilitates download of the updated prices and other pricing data to mobile transmission devices for transmission to receiving display terminals associated with the stock keeping units (SKUs) of the items.

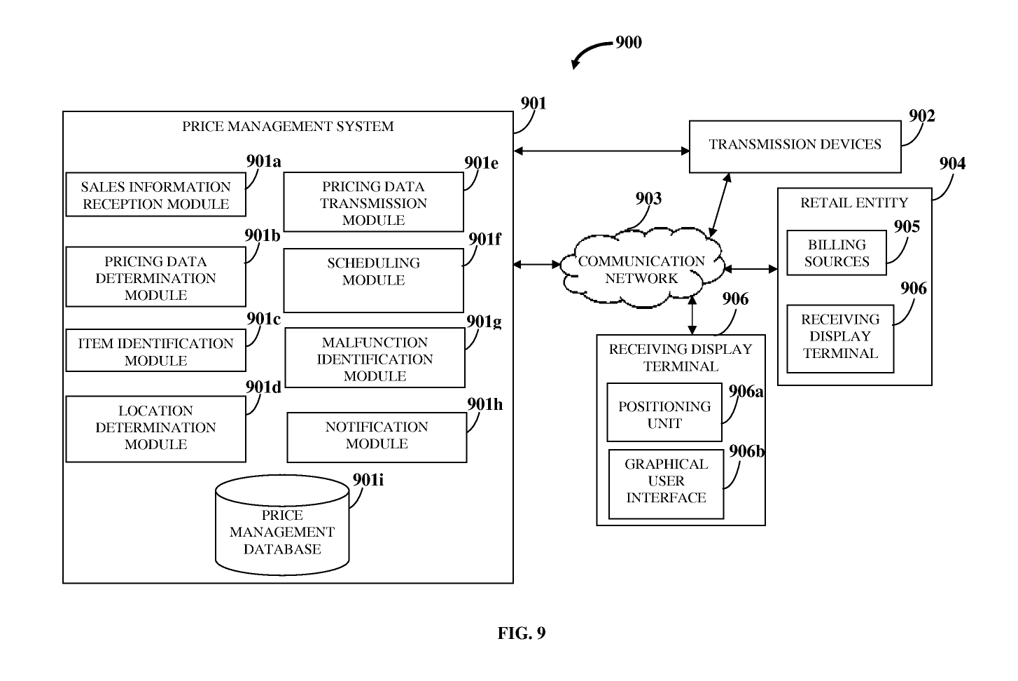

FIG. 9 exemplarily illustrates a system 900 for dynamically managing prices of multiple items in a retail entity 904. The system 900 disclosed herein comprises the price management system 901 in operable communication with one or more transmission devices 902 and one or more receiving display terminals 906 over a communication network 903. The price management system 901 is accessible, for example, through a broad spectrum of technologies and devices such as personal computers with access to the internet, internet enabled cellular phones, tablet computing devices, servers, etc. In an embodiment, the price management system 901 is implemented in a cloud computing environment. As used herein, “cloud computing environment” refers to a processing environment comprising configurable computing physical and logical resources, for example, networks, servers, storage, applications, services, etc., and data distributed over a communication network 903, for example, the internet. The cloud computing environment provides on-demand network access to a shared pool of the configurable computing physical and logical resources. In this embodiment, the price management system 901 is a cloud computing based platform implemented as a service for dynamically managing prices of multiple items in a retail entity 904. The price management system 901 is developed, for example, using the Google App engine cloud infrastructure of Google Inc., Amazon Web Services® of Amazon Technologies, Inc., the Amazon elastic compute EC2® web service of Amazon Technologies, Inc., the Google® Cloud platform of Google Inc., the Microsoft® Cloud platform of Microsoft Corporation, etc. In another embodiment, the price management system 901 is configured as a web based platform, for example, a website hosted on a server or a network of servers.

In another embodiment, the price management system 901 comprises a price management software application downloadable on the transmission devices 902 and accessible by management staff at the retail entity 904. The transmission devices 902 are electronic devices, for example, personal computers, tablet computing devices, mobile computers, mobile phones, smart phones, portable computing devices, laptops, personal digital assistants, workstations, servers, client devices, portable electronic devices, network enabled computing devices, interactive network enabled communication devices, any other suitable computing equipment, combinations of multiple pieces of computing equipment, etc. In another embodiment, the transmission devices 902 are transmitters that broadcast pricing data to the receiving display terminals 906.

Each of the receiving display terminals 906 is configured with a positioning unit 906a, for example, a global positioning system (GPS) receiver. The receiving display terminals 906 are positioned at the retail entity 904 or at one or more remote locations outside the retail entity 904. In an embodiment, the receiving display terminals 906 are mobile receiving display terminals, for example, a mobile retail booth, a mobile kiosk, etc. In an embodiment, the mobile receiving display terminals are positioned in the premises of the retail entity 904 for a short period of time for promotion purposes, for example, for promotion of a brand such as CocaCola® of the Coca-Cola Company, in the retail entity 904 on a weekend. In another embodiment, the receiving display terminals 906 are stationary receiving display terminals, for example, electronic display tags. In an embodiment, the receiving display terminals 906 are configured with one or more light sources comprising, for example, light emitting diodes (LEDs) such as white light emitting diodes (WLEDs), compact fluorescent lamps (CFLs), halogen lamps, light bulbs, low voltage light bulbs, etc. In an embodiment, the light sources are decorative light sources. The receiving display terminals 906 can be powered using one or more power sources comprising, for example, a battery such as a dry cell battery, a solar energy power source, an electric power source, a heat power source, by mechanical friction, etc. In an embodiment, the receiving display terminals 906 comprise a graphical user interface (GUI) 906b. The GUI 906b is, for example, a display interface that displays the determined pricing data associated with the items.

The communication network 903 for linking the price management system 901 to the receiving display terminals 906, and in an embodiment, to the transmission devices 902 is, for example, the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

The price management system 901 disclosed herein comprises a non-transitory computer readable storage medium and at least one processor communicatively coupled to the non-transitory computer readable storage medium. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium is configured to store computer program instructions defined by modules, for example, 901a, 901b, 901c, 901d, 901e, 901f, 901g, 901h, etc., of the price management system 901. The processor is configured to execute the defined computer program instructions.

The price management system 901 comprises a sales information reception module 901a, a pricing data determination module 901b, an item identification module 901c, a location determination module 901d, a pricing data transmission module 901e, and a scheduling module 901f. The sales information reception module 901a dynamically receives sales information of the items from one or more billing sources 905 at the retail entity 904. The sales information reception module 901a periodically monitors the billing sources 905 via the communication network 903 for receiving the sales information. The pricing data determination module 901b determines pricing data for the items based on the dynamically received sales information and the pricing criteria. The pricing data determination module 901b determines a sales pattern associated with each of the items based on a change of sale of each of the items with a change of the prices extracted from the dynamically received sales information for determination of the pricing data for the items.

The item identification module 901c of the price management system 901 identifies one or more items requiring a change of the prices based on the determined pricing data. The location determination module 901d, in communication with the positioning unit 906a of each of the receiving display terminals 906, locates one or more of the receiving display terminals 906 associated with the identified items. The positioning unit 906a of each of the receiving display terminals 906 is in operable communication with a satellite system for allowing the location determination module 901d to locate the receiving display terminals 906 associated with the identified items. The satellite system is, for example, a global positioning system (GPS) or a low earth orbiting satellite system. In an embodiment, the pricing data determination module 901b configures the determined pricing data in one or more languages for a selective display of the determined pricing data in those languages on the located receiving display terminals 906.

In an embodiment, the price management system 901 further comprises a price management database 901i configured to store the dynamically received sales information and the determined pricing data. The price management database 901i is any storage area or medium that can be used for storing data and files. The price management database 901i is, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the price management database 901i can also be a location on a file system. In another embodiment, the price management database 901i can be remotely accessed by the price management system 901 via the communication network 903. In another embodiment, the price management database 901i is configured as a cloud based database implemented in a cloud computing environment, where computing resources are delivered as a service over the communication network 903, for example, the internet.

The scheduling module 901f of the price management system 901 configures one or more time instants for changing the prices of the identified items based on the dynamically received sales information. The pricing data transmission module 901e transmits the determined pricing data for the identified items to the transmission devices 902. The transmission devices 902 receive the determined pricing data for the identified items from the price management system 901 and transmit the determined pricing data to the located receiving display terminals 906 at the configured time instants. In an embodiment, the transmission devices 902 are configured as mobile transmission devices for transmitting the determined pricing data to the located receiving display terminals 906, when positioned proximal to the located receiving display terminals 906. In an embodiment, the transmission devices 902 transmit the determined pricing data to the located receiving display terminals 906 via one or more wired communication modes, one or more wireless communication modes, and any combination thereof.

The price management system 901 further comprises a malfunction identification module 901g and a notification module 901h. The malfunction identification module 901g identifies malfunctioning of the receiving display terminals 906 based on a comparison of pricing data displayed by the receiving display terminals 906 with the determined pricing data transmitted by the pricing data transmission module 901e. The receiving display terminals 906 transmit the displayed pricing data to the price management system 901 via the transmission devices 902 for facilitating the comparison. In an embodiment, the malfunction identification module 901g identifies the malfunctioning receiving display terminals 906 by receiving one or more images of the receiving display terminals 906 displaying the determined pricing data from one or more image capture devices (not shown) positioned proximal to the receiving display terminals 906 and analyzing the received images. The notification module 901h generates and transmits a notification to the retail entity 904 to indicate the malfunctioning of one or more of the receiving display terminals 906 and the identified malfunctioning receiving display terminals 906. The maintenance staff at the retail entity 904, for example, staff in the maintenance office at the retail entity 904 can repair or replace the malfunctioning receiving display terminals 906 on receiving this notification.

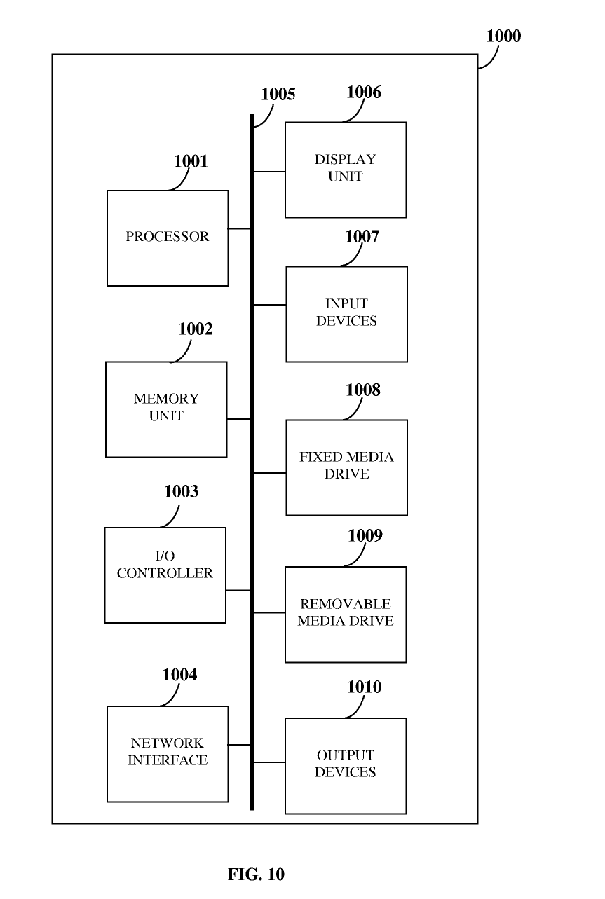

FIG. 10 exemplarily illustrates a hardware architecture 1000 of the price management system 901 exemplarily illustrated in FIG. 9, for dynamically managing prices of multiple items in a retail entity 904. The price management system 901 is a computer system that is programmable using a high level computer programming language. The price management system 901 may be implemented using programmed and purposeful hardware. The price management system 901 communicates with one or more transmission devices 902 and the receiving display terminals 906 over the communication network 903 exemplarily illustrated in FIG. 9, for example, a short range network or a long range network.

As exemplarily illustrated in FIG. 10, the hardware architecture 1000 of the price management system 901 comprises a processor 1001, a non-transitory computer readable storage medium such as a memory unit 1002 for storing programs and data, an input/output (I/O) controller 1003, a network interface 1004, a data bus 1005, a display unit 1006, input devices 1007, a fixed media drive 1008 such as a hard drive, a removable media drive 1009 for receiving removable media, output devices 1010, etc. The processor 1001 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 1001 may also be implemented as a processor set comprising, for example, a general purpose microprocessor and a math or graphics co-processor. The processor 1001 is selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The price management system 901 disclosed herein is not limited to employing a processor 1001. The price management system 901 may also employ a controller or a microcontroller. The processor 1001 executes the modules, for example, 901a, 901b, 901c, 901d, 901e, 901f, 901g, 901h, etc., of the price management system 901.

The memory unit 1002 is used for storing programs, applications, and data. For example, the sales information reception module 901a, the pricing data determination module 901b, the item identification module 901c, the location determination module 901d, the pricing data transmission module 901e, the scheduling module 901f, the malfunction identification module 901g, the notification module 901h, etc., are stored in the memory unit 1002 of the price management system 901. The memory unit 1002 is, for example, a random access memory (RAM) or another type of dynamic storage device that stores information and instructions for execution by the processor 1001. The memory unit 1002 also stores temporary variables and other intermediate information used during execution of the instructions by the processor 1001. The price management system 901 further comprises a read only memory (ROM) or another type of static storage device that stores static information and instructions for the processor 1001. The I/O controller 1003 controls input actions and output actions performed by the price management system 901.

The network interface 1004 enables connection of the price management system 901 to the communication network 903. In an embodiment, the network interface 1004 is provided as an interface card also referred to as a line card. The network interface 1004 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 1005 permits communications between the modules, for example, 901a, 901b, 901c, 901d, 901e, 901f, 901g, 901h, 901i, etc., of the price management system 901.

The display unit 1006 displays information, display interfaces, user interface elements such as text fields, checkboxes, text boxes, windows, etc., for allowing an administrator of the price management system 901 to enter inputs for dynamically managing prices of multiple items. The display unit 1006 comprises, for example, a liquid crystal display, a plasma display, an organic light emitting diode (OLED) based display, etc. The input devices 1007 are used for inputting data into the price management system 901. The administrator of the price management system 901 uses the input devices 1007 to provide inputs to the price management system 901. The inputs comprise, for example, the sales information for an item, a higher limit for the updated price of the item, a lower limit for the updated price of the item, messages associated with the item, an image of the item, etc, using the input devices 1007. The input devices 1007 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the price management system 901. The programs are loaded onto the fixed media drive 1008 and into the memory unit 1002 of the price management system 901 via the removable media drive 1009. In an embodiment, the computer applications and programs may be loaded directly via the communication network 903. Computer applications and programs are executed by double clicking a related icon displayed on the display unit 1006 using one of the input devices 1007. The output devices 1010 output the results of operations performed by the price management system 901. For example, the price management system 901 outputs the determined pricing data for the items such as the updated prices for the items using the output devices 1010.

The processor 1001 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian™ operating system of Symbian Foundation Limited, etc. The price management system 901 employs the operating system for performing multiple tasks. The operating system is responsible for management and coordination of activities and sharing of resources of the price management system 901. The operating system further manages security of the price management system 901, peripheral devices connected to the price management system 901, and network connections. The operating system employed on the price management system 901 recognizes, for example, inputs provided by an administrator of the price management system 901 using one of the input devices 1007, the output display, files, and directories stored locally on the fixed media drive 1008. The operating system executes different programs using the processor 1001. The processor 1001 and the operating system together define a computer platform for which application programs in high level programming languages are written.

The processor 1001 of the price management system 901 retrieves instructions defined by the sales information reception module 901a, the pricing data determination module 901b, the item identification module 901c, the location determination module 901d, the pricing data transmission module 901e, the scheduling module 901f, the malfunction identification module 901g, the notification module 901h, etc., for performing respective functions disclosed in the detailed description of FIG. 9. The processor 1001 retrieves instructions for executing the modules, for example, 901a, 901b, 901c, 901d, 901e, 901f, 901g, 901h, etc., of the price management system 901 from the memory unit 1002. A program counter determines the location of the instructions in the memory unit 1002. The program counter stores a number that identifies the current position in the program of each of the modules, for example, 901a, 901b, 901c, 901d, 901e, 901f, 901g, 901h, etc., of the price management system 901. The instructions fetched by the processor 1001 from the memory unit 1002 after being processed are decoded. The instructions are stored in an instruction register in the processor 1001. After processing and decoding, the processor 1001 executes the instructions, thereby performing one or more processes defined by those instructions.

At the time of execution, the instructions stored in the instruction register are examined to determine the operations to be performed. The processor 1001 then performs the specified operations. The operations comprise arithmetic operations and logic operations. The operating system performs multiple routines for performing a number of tasks required to assign the input devices 1007, the output devices 1010, and memory for execution of the modules, for example, 901a, 901b, 901c, 901d, 901e, 901f, 901g, 901h, etc., of the price management system 901. The tasks performed by the operating system comprise, for example, assigning memory to the modules, for example, 901a, 901b, 901c, 901d, 901e, 901f, 901g, 901h, etc., of the price management system 901, and to data used by the price management system 901, moving data between the memory unit 1002 and disk units, and handling input/output operations. The operating system performs the tasks on request by the operations and after performing the tasks, the operating system transfers the execution control back to the processor 1001. The processor 1001 continues the execution to obtain one or more outputs. The outputs of the execution of the modules, for example, 901a, 901b, 901c, 901d, 901e, 901f, 901g, 901h, etc., of the price management system 901 are displayed on the display unit 1006 to an administrator of the price management system 901.

For purposes of illustration, the detailed description refers to the price management system 901 being run locally on a single computer system; however the scope of the method and system 900 disclosed herein is not limited to the price management system 901 being run locally on a single computer system via the operating system and the processor 1001, but may be extended to run remotely over the communication network 903 by employing a web browser and a remote server, a mobile phone, or other electronic devices. One or more portions of the price management system 901 may be distributed across one or more computer systems (not shown) coupled to the communication network 903.

Disclosed herein is also a computer program product comprising a non-transitory computer readable storage medium that stores computer program codes comprising instructions executable by at least one processor 1001 for dynamically managing prices of multiple items in a retail entity 904 exemplarily illustrated in FIG. 9. The computer program product disclosed herein comprises a first computer program code for dynamically receiving sales information of the items from one or more billing sources 905 at the retail entity 904; a second computer program code for determining pricing data for the items based on the dynamically received sales information and pricing criteria; a third computer program code for identifying one or more of the items requiring a change of the prices based on the determined pricing data; a fourth computer program code for locating one or more of the receiving display terminals 906 associated with the identified items, in communication with the positioning unit 906a of each of the receiving display terminals 906; and a fifth computer program code for transmitting the determined pricing data for the identified items to the located receiving display terminals 906 via one or more transmission devices 902 at one or more time instants.

The computer program product disclosed herein further comprises a sixth computer program code for determining a sales pattern associated with each of the items based on a change of sale of each of the items with the change of the prices extracted from the dynamically received sales information for the determination of the pricing data for the items. The computer program product disclosed herein further comprises a seventh computer program code for identifying malfunctioning of the receiving display terminals 906 based on a comparison of pricing data displayed by the receiving display terminals 906 with the determined pricing data. The computer program product disclosed herein further comprises an eighth computer program code for identifying malfunctioning of the receiving display terminals 906 by receiving one or more images of the receiving display terminals 906 displaying the pricing data from one or more image capture devices (not shown) positioned proximal to the receiving display terminals 906 and analyzing the received images.

The computer program product disclosed herein further comprises one or more additional computer program codes for performing additional steps that may be required and contemplated for dynamically managing prices of multiple items in a retail entity 904. In an embodiment, a single piece of computer program code comprising computer executable instructions performs one or more steps of the method disclosed herein for dynamically managing prices of multiple items in a retail entity 904. The computer program codes comprising computer executable instructions are embodied on the non-transitory computer readable storage medium. The processor 1001 of the price management system 901 retrieves these computer executable instructions and executes them. When the computer executable instructions are executed by the processor 1001, the computer executable instructions cause the processor 1001 to perform the steps of the method for dynamically managing prices of multiple items in a retail entity 904.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Perl®, Python®, Visual Basic®, hypertext preprocessor (PHP), Microsoft® .NET etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises one or more computer program codes for implementing the processes of various embodiments.

Where databases are described such as the price management database 901i, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method for dynamically managing prices of a plurality of items in a retail entity, said method comprising:
providing a price management system comprising at least one processor, in operable communication with one or more transmission devices and a plurality of receiving display terminals, each of said receiving display terminals configured with a positioning unit and positioned at one of said retail entity and a remote location;
dynamically receiving sales information of said items from one or more of a plurality of billing sources at said retail entity by said price management system;
determining pricing data for said items by said price management system based on said dynamically received sales information and pricing criteria;
identifying one or more of said items requiring a change of said prices by said price management system based on said determined pricing data;
locating one or more of said receiving display terminals associated with said identified one or more of said items by said price management system in communication with said positioning unit of said each of said receiving display terminals; and
transmitting said determined pricing data for said identified one or more of said items to said located one or more of said receiving display terminals by said price management system via said one or more transmission devices at one or more time instants configured by said price management system.

2. The method of claim 1, wherein said sales information comprises an identification code of each of said items, an original price of said each of said items, an expiration date of said each of said items, an image of said each of said items, a quantity of said each of said items processed by said billing sources in a predefined time period, an identification code of said each of said receiving display terminals associated with said each of said items, and feedback sales data.

3. The method of claim 1, wherein said pricing criteria comprise a type of an item, an expiration date of said item, and a quantity of said item in an inventory of said retail entity.

4. The method of claim 1, further comprising determining a sales pattern associated with each of said items by said price management system based on a change of sale of said each of said items with said change of said prices extracted from said dynamically received sales information for said determination of said pricing data for said items.

5. The method of claim 1, wherein said pricing data comprises an identification code of each of said items, a name of said each of said items, an updated price of said each of said items, an image of said each of said items, and one or more messages associated with said each of said items.

6. The method of claim 1, further comprising configuring said one or more time instants for changing said prices of said identified one or more of said items by said price management system based on said dynamically received sales information.

7. The method of claim 1, further comprising periodically monitoring said billing sources by said price management system via a communication network for receiving said sales information.

8. The method of claim 1, further comprising identifying malfunctioning of said receiving display terminals by said price management system based on a comparison of pricing data displayed by said receiving display terminals with said determined pricing data, wherein said receiving display terminals are configured to transmit said displayed pricing data to said price management system via said one or more transmission devices for facilitating said comparison.

9. The method of claim 1, further comprising identifying malfunctioning of said receiving display terminals by said price management system by receiving one or more images of said receiving display terminals displaying said pricing data from one or more image capture devices positioned proximal to said receiving display terminals and analyzing said received one or more images.

10. The method of claim 1, further comprising generating and transmitting a notification configured to indicate malfunctioning of one or more of said receiving display terminals by said price management system to said retail entity.

11. The method of claim 1, wherein said one or more transmission devices are configured as mobile transmission devices configured to transmit said determined pricing data to said located one or more of said receiving display terminals when positioned proximal to said located one or more of said receiving display terminals.

12. The method of claim 1, wherein said one or more transmission devices are configured to transmit said determined pricing data to said located one or more of said receiving display terminals via one or more wired communication modes, one or more wireless communication modes, and any combination thereof.

13. The method of claim 1, further comprising configuring said determined pricing data in one or more of a plurality of languages by said price management system for a selective display of said determined pricing data in said one or more of said languages on said located one or more of said receiving display terminals.

14. A system for dynamically managing prices of a plurality of items in a retail entity, said system comprising:
a plurality of receiving display terminals, each of said receiving display terminals configured with a positioning unit and positioned at one of said retail entity and a remote location;
a price management system in operable communication with said receiving display terminals, said price management system comprising:
a non-transitory computer readable storage medium configured to store computer program instructions defined by modules of said price management system;
at least one processor communicatively coupled to said non-transitory computer readable storage medium, said at least one processor configured to execute said modules of said price management system; and
said modules of said price management system comprising:
a sales information reception module configured to dynamically receive sales information of said items from one or more of a plurality of billing sources at said retail entity;
a pricing data determination module configured to determine pricing data for said items based on said dynamically received sales information and pricing criteria;
an item identification module configured to identify one or more of said items requiring a change of said prices based on said determined pricing data;
a location determination module configured to locate one or more of said receiving display terminals associated with said identified one or more of said items, in communication with said positioning unit of said each of said receiving display terminals; and
a pricing data transmission module configured to transmit said determined pricing data for said identified one or more of said items to one or more transmission devices; and
said one or more transmission devices in operable communication with said price management system, said one or more transmission devices configured to receive said determined pricing data for said identified one or more of said items from said price management system and transmit said determined pricing data to said located one or more of said receiving display terminals at one or more time instants.

15. The system of claim 14, wherein said sales information comprises an identification code of each of said items, an original price of said each of said items, an expiration date of said each of said items, an image of said each of said items, a quantity of said each of said items processed by said billing sources in a predefined time period, an identification code of said each of said receiving display terminals associated with said each of said items, and feedback sales data.

16. The system of claim 14, wherein said pricing criteria comprise a type of an item, an expiration date of said item, and a quantity of said item in an inventory of said retail entity.

17. The system of claim 14, wherein said pricing data determination module of said price management system is further configured to determine a sales pattern associated with each of said items based on a change of sale of said each of said items with said change of said prices extracted from said dynamically received sales information for said determination of said pricing data for said items.

18. The system of claim 14, wherein said pricing data comprises an identification code of each of said items, a name of said each of said items, an updated price of said each of said items, an image of said each of said items, and one or more messages associated with said each of said items.

19. The system of claim 14, wherein said modules of said price management system further comprise a scheduling module configured to configure said one or more time instants for changing said prices of said identified one or more of said items based on said dynamically received sales information.

20. The system of claim 14, wherein said sales information reception module of said price management system is further configured to periodically monitor said billing sources via a communication network for receiving said sales information.

21. The system of claim 14, wherein said modules of said price management system further comprise a malfunction identification module configured to identify malfunctioning of said receiving display terminals based on a comparison of pricing data displayed by said receiving display terminals with said determined pricing data, wherein said receiving display terminals are configured to transmit said displayed pricing data to said price management system via said one or more transmission devices for facilitating said comparison.

22. The system of claim 14, wherein said modules of said price management system further comprise a malfunction identification module configured to identify said malfunctioning of said receiving display terminals by receiving one or more images of said one or more receiving display terminals displaying said pricing data from one or more image capture devices positioned proximal to said receiving display terminals and analyzing said received one or more images.

23. The system of claim 14, wherein said modules of said price management system further comprise a notification module configured to generate and transmit a notification configured to indicate malfunctioning of one or more of said receiving display terminals to said retail entity.

24. The system of claim 14, wherein said one or more transmission devices are configured as mobile transmission devices configured to transmit said determined pricing data to said located one or more of said receiving display terminals when positioned proximal to said located one or more of said receiving display terminals.

25. The system of claim 14, wherein said one or more transmission devices are configured to transmit said determined pricing data to said located one or more of said receiving display terminals via one or more wired communication modes, one or more wireless communication modes, and any combination thereof.

26. The system of claim 14, wherein said pricing data determination module of said price management system is further configured to configure said determined pricing data in one or more of a plurality of languages for a selective display of said determined pricing data in said one or more of said languages on said located one or more of said receiving display terminals.

27. The system of claim 14, wherein said positioning unit of said each of said receiving display terminals is in operable communication with a satellite system for allowing said location determination module of said price management system to locate said one or more of said receiving display terminals associated with said identified one or more of said items.

28. A computer program product comprising a non-transitory computer readable storage medium, said non-transitory computer readable storage medium storing computer program codes that comprise instructions executable by at least one processor, said computer program codes comprising:
a first computer program code for dynamically receiving sales information of a plurality of items from one or more of a plurality of billing sources at a retail entity;
a second computer program code for determining pricing data for said items based on said dynamically received sales information and pricing criteria, wherein said pricing criteria comprise a type of an item, an expiration date of said item, and a quantity of said item in an inventory of said retail entity;
a third computer program code for identifying one or more of said items requiring a change of said prices based on said determined pricing data;
a fourth computer program code for locating one or more of a plurality of receiving display terminals associated with said identified one or more of said items, in communication with a positioning unit of each of said receiving display terminals; and
a fifth computer program code for transmitting said determined pricing data for said identified one or more of said items to said located one or more of said receiving display terminals via one or more transmission devices at one or more time instants.

29. The computer program product of claim 28, wherein said computer program codes further comprise a sixth computer program code for determining a sales pattern associated with each of said items based on a change of sale of said each of said items with said change of said prices extracted from said dynamically received sales information for said determination of said pricing data for said items.

30. The computer program product of claim 28, wherein said computer program codes further comprise a seventh computer program code for identifying malfunctioning of said receiving display terminals based on a comparison of pricing data displayed by said receiving display terminals with said determined pricing data.

31. The computer program product of claim 28, wherein said computer program codes further comprise an eighth computer program code for identifying malfunctioning of said receiving display terminals by receiving one or more images of said receiving display terminals displaying said pricing data from one or more image capture devices positioned proximal to said receiving display terminals and analyzing said received one or more images.
